(19) United States
(12) Patent Application Publication
(10) Pub. No.: US 2026/0234311 A1
(43) Pub. Date: Aug. 13, 2026

(54) STARCH HYBRID COPOLYMERS

(71) Applicant: WACKER CHEMIE AG, Munich (DE)

(72) Inventors: Yong-Hae CHOI, Seongnam-si (KR); HyungSup CHOI, Seongnam-si (KR); DaeKyu KANG, Seongnam-si (KR); Jong-Bok KIM, Seongnam-si (KR); Sung OH, Seongnam-si (KR)

(73) Assignee: WACKER CHEMIE AG, Munich (DE)

(21) Appl. No.: 19/158,064

(22) PCT Filed: Mar. 9, 2023
(86) PCT No.: PCT/EP2023/056075

§ 371 Date: Aug. 20, 2025

(51) Int. Cl. C08F 251/00; C08B 31/18

(52) U.S. Cl. CPC C08F 251/00; C08B 31/185

(57) ABSTRACT

Provided are starch hybrid copolymers and methods of producing starch hybrid copolymers available as aqueous dispersions or water-redispersible powders, produced by radically initiated polymerization of ethylenically unsaturated monomers comprising at least one vinyl ester and ethylene which compose at least 81 wt. % of the total monomers in the presence of oxidized starch, with optional subsequent drying. Such copolymers are suitable for use in adhesives, coating compositions, and various chemical products, particularly in the construction industry, as well as in flexible packaging, food containers, coffee capsules, straws, mulching films, pesticide coatings, fishing nets, and 3D printing compositions.

The invention relates to starch hybrid copolymers based on oxidized starch, vinyl acetate and ethylene in the form of aqueous dispersions or water-redispersible powders, to processes for producing them and to their use in adhesive or coating compositions, such as for flexible packaging, food containers, coffee capsules, straw, mulching films, pesticide coatings or fishing nets, or in compositions for 3D printing.

For ecological reasons and to solve the plastic waste issue, there is a need to provide biodegradable polymers and to replace petrochemical polymers at least partially by natural, renewable raw materials, such as starch. But such replacement should preferably not impair application properties of the application products, particularly mechanical properties, such as elongation, tensile strength or impact strength. Also the compatibility of natural, renewable raw materials with other recipe ingredients of adhesive or coating compositions can be an issue. Such application and compatibility properties are generally not achieved with mere physical blends of starch and petrochemical polymers. Also with starch hybrid copolymers there can be problems in achieving the desired property profile. Starch hybrid copolymers are based on polymers of ethylenically unsaturated monomers and starch, which may be linked to one another via chemical bonds, for example, or bonded to one another in some other way.

A particular problem arises from the fact that starch and petrochemical polymers have completely different chemical structures and properties. Therefore, partial substitution of petrochemical polymers by starch can lead to incompatibilities and segregation of the different substances, which massively affects the property profile of the application products. Starch must therefore be present with the petrochemical polymers in a stable form. Since different petrochemical polymers have different property profiles, it is also not possible to transfer findings on one starch hybrid polymer to another based on different petrochemical polymers. Petrochemical polymers differ greatly in their properties depending on their monomer composition, for instance in their hydrophily or hydrophobicity, solubility or dispersibility, elastic or nonelastic properties or general in their thermal behaviour. Also functional comonomer-units, such as allyl-, epoxy-, silane- or N-methylol-groups bearing comonomer-units, have great impact on the polymer properties, since such monomers are, for instance, crosslinking and may react with starch and, thereby, stabilize the starch hybrid copolymers.

Some approaches to the production of starch hybrid copolymers are already known. For instance, KR101473916B1 describes starch-based polymer particles having core-shell structure, which are obtained by polymerizing hard and soft monomers in the presence of starch degradation products to form the core, onto which hard monomers, soft monomers and silane monomers are polymerized as the shell. The soft monomers of KR101473916B1 are certain acrylates which form homopolymers with glass transition temperatures of 10° C. to −80° C. Ethylene homopolymers, in contrast, have a glass transition temperature of −85° C.

The graft polymers of U.S. Pat. No. 4,301,017 are produced by polymerizing a single or at least two vinyl monomers in the presence of derivatized starch whereby the at least two vinyl monomers are acrylate monomers. WO15160794A1 describes biobased nanoparticles of biopolymers and vinyl monomers. In WO11008272A1, hydrophobically modified starch was produced by reacting water-soluble polysaccharides with hydrophilic monomers and hydrophobic monomers, followed by polymerization with a further monomer mixture. WO2015155159 teaches an aqueous emulsion polymerization of 70 to 95 wt % of vinyl acetate and 5 to 25 wt % of (meth)acrylic esters and also defined amounts of certain functional monomers, such as allyl- or glycidyl-acrylates, in the presence of starch. WO2022/218539 teaches starch hybrid copolymers with vinyl esters, ethylene, ethylenically unsaturated functional monomers carrying epoxy, silane and/or N-methylol groups.

Starch has also been recommended as protective colloid for polymers, such as in U.S. Pat. No. 3,632,535, for example. EP1082370B1 concretely describes styrene-acrylate polymers stabilized by starch. U.S. Pat. No. 3,769,248 describes vinyl acetate polymer dispersions stabilized with up to 4 wt % of starch as protective colloid. U.S. Pat. No. 4,532,295 teaches emulsion polymerizations of ethylenically unsaturated monomers in the presence of 1 to 5 wt %, based on the monomers, of cyanoalkyl-, hydroxyalkyl- or carboxyalkyl-starch as protective colloid. For U.S. Pat. No. 4,532,295 it is essential to omit emulsifiers during the polymerization. Protective colloids are known to have the function of stabilizing polymers. For example, aqueous dispersions of water-insoluble polymers can be stabilized by protective colloids. With protective colloids it is also possible for water-insoluble polymers to be converted into water-redispersible powders. In these cases, the water-insoluble polymers and the protective colloid starch take the form of separate polymers. Compositions in which starch and other polymers are present alongside one another are also referred to as physical mixtures or blends.

Against this background, the object was to provide starch hybrid copolymers which show advantageous biodegradability, particularly in home composting condition, and preferably beneficial storage stability. Preferably, films made from the starch hybrid copolymers exhibit advantageous mechanical properties, such as elongation.

A subject of the invention are starch hybrid copolymers in the form of aqueous dispersions or water-redispersible powders obtainable by radically initiated polymerization in aqueous medium of ethylenically unsaturated monomers in the presence of starch and optionally subsequent drying, characterized in that
the starch comprises oxidized starch and
the ethylenically unsaturated monomers comprise one or more vinyl ester and ethylene,
wherein the total amount of vinyl ester and ethylene is ≥81 wt.-%, based on the total weight of the ethylenically unsaturated monomers,
whereby no ethylenically unsaturated monomer bearing allyl-, epoxy-, silane- or N-methylol-groups is copolymerized.

Examples of vinyl esters are vinyl esters of unbranched or branched alkylcarboxylic acids having 1 to 18 carbon atoms, such as vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 5 to 15 carbon atoms, for example VeoVa9® or VeoVa10® (tradenames of Shell). Vinyl acetate is preferred.

The starch hybrid copolymers are based preferably 50 to 97 wt %, more preferably 70 to 95 wt % and most preferably 80 to 90 wt % on vinyl esters, based on the total weight of the ethylenically unsaturated monomers.

The starch hybrid copolymers are based preferably 40 to 80 wt %, more preferably 45 to 75 wt % and most preferably 50 to 70 wt % on vinyl esters, based on the dry weight of the starch hybrid copolymers.

The starch hybrid copolymers are based preferably 1 to 45 wt %, more preferably 3 to 30 wt %, even more preferably 5 to 25 wt % and most preferably 10 to 20 wt % on ethylene, based on the total weight of the ethylenically unsaturated monomers.

The starch hybrid copolymers are based preferably 1 to 45 wt %, more preferably 3 to 30 wt % and most preferably 5 to 20 wt % on ethylene, based on the dry weight of the starch hybrid copolymers.

The total amount of vinyl ester and ethylene is preferably ≥85 wt.-%, more preferably ≥91 wt.-%, even more preferably ≥96 wt % and most preferably ≥99 wt %, based on the total weight of the ethylenically unsaturated monomers.

The total amount of vinyl ester and ethylene is preferably 40 to 95 wt %, more preferably 45 to 90 wt %, even more preferably 50 to 85 wt % and most preferably 60 to 80 wt %, based on the dry weight of the starch hybrid copolymers.

Most preferably, the ethylenically unsaturated monomers consist of vinyl ester and ethylene, particularly of vinyl acetate and ethylene.

The starch hybrid copolymers may be based on one or more further ethylenically unsaturated monomers, such as acrylic esters or methacrylic esters of branched or unbranched alcohols having 1 to 15 carbon atoms, dienes, propene, vinyl halides and vinylaromatics.

Examples of (meth)acrylic esters are acrylic esters or methacrylic esters of branched or unbranched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate, 2-ethylhexyl acrylate and norbornyl acrylate.

Particularly preferred are methyl acrylate, methyl methacrylate, n-butyl acrylate, 2-ethylhexyl acrylate and norbornyl acrylate.

Examples of suitable dienes are 1,3-butadiene and isoprene. An example for a vinyl halide is vinyl chloride. Vinylaromatics copolymerized may be styrene or vinyltoluene, for example.

Preferred further monomers are n-butyl acrylate, n-butyl methacrylate, tert-butyl acrylate and tert-butyl methacrylate.

Such further ethylenically unsaturated monomers are copolymerized to an extent of preferably 0 to 19 wt %, more preferably 0.1 to 9 wt % and even more preferably 0.5 to 4 wt %, based on the total weight of the monomers.

Such further ethylenically unsaturated monomers are copolymerized to an extent of preferably 0 to 10 wt %, more preferably 0 to 8 wt % and even more preferably 0.1 to 5 wt %, based on the total weight of the starch hybrid copolymers.

Most preferably, no further ethylenically unsaturated monomers are copolymerized, particularly no (meth)acrylic esters and/or no vinylaromatics.

The starch hybrid copolymers may optionally be based additionally on one or more auxiliary monomers. Preferably 0 to 19 wt %, more preferably 0.01 to 10 wt %, even more preferably 0.1 to 1 wt % of auxiliary monomers are copolymerized, based on the total weight of the monomers. Examples of auxiliary monomers are ethylenically unsaturated monocarboxylic and dicarboxylic acids, preferably acrylic acid, methacrylic acid, crotonic acid, fumaric acid and maleic acid; ethylenically unsaturated anhydrides, preferably maleic anhydride; acrylamide; ethylenically unsaturated carbonitriles, preferably acrylonitrile; monoesters and diesters of fumaric acid and maleic acid such as the diethyl and diisopropyl esters; ethylenically unsaturated sulfonic acids and their salts, preferably vinylsulfonic acid and 2-acrylamido-2-methylpropanesulfonic acid.

Preferred auxiliary monomers are ethylenically unsaturated monocarboxylic and dicarboxylic acids or their anhydrides and particularly ethylenically unsaturated sulfonic acids or their salts.

Most preferably, no auxiliary monomers are copolymerized.

For the preparation of the starch hybrid copolymers, no ethylenically unsaturated monomer bearing allyl-, epoxy-, silane- or N-methylol-groups is copolymerized. The starch hybrid copolymers do generally not contain monomer units from allyl-, epoxy, silane- or N-methylol-group bearing monomers.

Examples of ethylenically unsaturated monomers with allyl-groups are allyl ester of a unsaturated carboxylic acid, such as allyl methacrylate or allyl acrylate.

Examples of ethylenically unsaturated monomers carrying epoxy groups are glycidyl acrylate and glycidyl methacrylate.

Examples of ethylenically unsaturated monomers carrying N-methylol groups are N-alkylol-functional comonomers with a C₁ to C₄ alkylol radical, more particularly N-methylol radical, such as N-methylolacrylamide (NMA), N-methylolmethacrylamide, N-methylolallyl carbamate, C₁ to C₄ alkyl ethers of N-methylolacrylamide, N-methylolmethacrylamide and N-methylolallyl carbamate, such as their isobutoxy ethers, for example, and also C₁ to C₄ alkyl esters of N-methylolacrylamide, of N-methylolmethacrylamide and of N-methylolallyl carbamate. Particularly preferred are N-methylolacrylamide, N-methylolmethacrylamide, N-methylolallyl carbamate and C₁ to C₄ alkyl ethers of N-methylolacrylamide such as the isobutoxy ether.

Ethylenically unsaturated monomers carrying silane groups encompass, for example, (meth)acryloyloxypropyltri(alkoxy)silanes or (meth)acryloyloxypropyldialkoxymethylsilanes, vinyltrialkoxysilanes or vinylmethyldialkoxysilanes, where alkoxy groups included may be, for example, methoxy, ethoxy, propoxy, butoxy, acetoxy and ethoxypropylene glycol ether radicals. Preferred ethylenically unsaturated silanes are vinyltrimethoxysilane, vinylmethyldimethoxysilane, vinyltriethoxysilane, vinylmethyldiethoxysilane, vinyltripropoxysilane, vinyltriisopropoxysilane, vinyltris(1-methoxy)isopropoxysilane, vinyltributoxysilane, vinyltriacetoxysilane, 3-methacryloyloxypropyltrimethoxysilane, 3-methacryloyloxypropylmethyldimethoxysilane, methacryloyloxymethyltrimethoxysilane, 3-methacryloyloxypropyltris(2-methoxyethoxy)silane, vinyltrichlorosilane, vinylmethyldichlorosilane, vinyltris(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexyloxysilane, vinyltrioctyloxysilane, vinyldimethoxyoctyloxysilane, vinylmethoxydioctyloxysilane, vinylmethoxydilauryloxysilane, vinyldimethoxylauryloxysilane, and polyethylene glycol-modified silanes. Particularly preferred ethylenically unsaturated silanes are vinyltrimethoxysilane, vinylmethyldimethoxysilane, vinyltriethoxysilane, vinylmethyldiethoxysilane, vinyltris(1-methoxy)isopropoxysilane, methacryloyloxypropyltris(2-methoxyethoxy)silane, 3-methacryloyloxypropyltrimethoxysilane, 3-methacryloyloxypropylmethyldimethoxysilane and methacryloyloxymethyltrimethoxysilane.

The starch hybrid copolymers are based preferably 45 to 95 wt %, more preferably 50 to 90 wt % and most preferably 55 to 85 wt % on ethylenically unsaturated monomers, each based on the dry weight of the starch hybrid copolymers.

The fraction of the ethylenically unsaturated monomers in the starch hybrid copolymers may be ascertained for example by means of NMR spectroscopy, preferably using calibration substances.

The monomer selection and the selection of the weight fractions of the comonomers are made here such that the starch hybrid copolymers have a glass transition temperature Tg of −50° C. to +120° C., preferably −35° C. to +45° C. The starch units generally do not exhibit a glass transition temperature. The glass transition temperature Tg of the polymers may be ascertained in a known way by Differential Scanning Calorimetry (DSC). The Tg may also be precalculated approximately using the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (wt %/100) of the monomer n, and Tgn is the glass transition temperature in kelvins of the homopolymer of the monomer n. Tg values for homopolymers are listed in Polymer Handbook, 2^{nd} edition, J. Wiley & Sons, New York (1975).

The oxidized starch has molecular weights of preferably 50,000 to 1,000,000 g/mol, more preferably 70,000 to 600,000 g/mol and most preferably 100,0000 to 400,000 g/mol.

The oxidized starch has a carboxyl content expressed as sodium carboxylate of preferably 0.1 to 6.0 wt. %, more preferably 3.0 to 5.0 wt. %, based on the total weight of the oxidized starch.

The oxidized starch has weight-average particle diameters Dw of between preferably 100 and 5000 nm, more preferably 200 to 3000 nm and most preferably 300 and 1000 nm. The parameters Dw and Dn and the particle size distribution are determined by means of laser light diffraction and laser light scattering on the basis of the starch hybrid copolymers using the LS13320 instrument with the PVAC.RF780D optical model, including PIDS, from Beckmann-Coulter, observing the protocol of the instrument manufacturer, after adequate dilution of the aqueous polymer dispersions with fully demineralized water.

The oxidized starch has a solubility at 60° C. of preferably 25 to 50 g per litre of water, more preferably 30 to 45 g per litre of water and most preferably 33 to 39 g per litre of water.

Aqueous solutions of the oxidized starch have Brookfield viscosities of preferably 2 to 1,500 mPas, more preferably 4 to 1,000 mPas, even more preferably 6 to 500 mPas and most preferably 8 to 300 mPas (determined with a Brookfield viscometer at 60° C. and 20 rpm with a solids content of the solutions of 10%). Such viscosities are particularly beneficial for solving the present object and for achieving the advantageous effects of the present invention, particularly for obtaining films with the starch hybrid copolymers having improved homogeneity and better mechanical properties.

The gelatinization temperature of the oxidized starch is preferably 45° C. to 90° C., more preferably 50° C. to 85° C. and most preferably 53° C. to 75° C. The gelatinization temperature is a well-established parameter in starch technology. Starch gelatinization is a process in which the intermolecular bonds of starch molecules are broken down in the presence of heat and water which finally dissolves the starch in water. The temperature at which such gelatinization begins, is characteristic for a starch species. The proposed gelatinization temperatures are also helpful to solve the present object even better, particularly to obtain stable aqueous dispersions or to avoid gelation.

The starch hybrid copolymers are based preferably 5 to 59 wt %, more preferably 10 to 50 wt % and most preferably 15 to 45 wt % on oxidized starch, each based on the dry weight of the starch hybrid copolymers. The starch content of the starch hybrid copolymers may be ascertained conventionally by NMR spectroscopy.

Typical sources for preparing the oxidized starch may be derived from, for example, tubers or roots, such as potatoes, maranta (arrowroot), manioc (tapioca) or sweet potato (batata); cereal seeds, such as wheat, maize, rye, rice, barley, millet, oats, triticale or sorghum; fruits, such as bananas, chestnuts, acorns, peas, beans or other legumes, or pith, such as sago. The oxidized starch preferably comes from tubers or roots, such as more particularly potatoes or manioc (tapioca), or cereals, such as more particularly wheat or maize. The oxidized starch may also be obtained from wastes, for example potato remnants or potato peelings.

The oxidized starch may be produced using the processes common place for that purpose. Starch may be oxidized by typical oxidizing agents, such as persulfates, peroxides, permanganates, perborates or preferably hypochlorites, particularly sodium hypochlorite. The oxidizing reaction may be effected in a number of ways, but generally it is simply carried out by slurrying the raw starch in aqueous solution and oxidizing it in this medium with an oxidizing agent. The oxidation reaction is generally carried out under alkaline conditions. The extent to which the starch may be oxidized may be widely varied, in common way, and will depend in part upon the nature of the oxidizing agent utilized, and conditions under which the reaction is completed. Sodium hypochlorite oxidized starches have been found to be particularly useful in the present invention.

Oxidized starch is also available commercially, for example from the company Samyang under the tradename Sunsize C3011 or from the company Deasang.

The fraction of the oxidized starch is preferably ≥50 wt %, more preferably ≥90 wt % and even more preferably ≥95 wt %, each based on the total weight of the starch included overall. Most preferably the starch present is exclusively oxidized starch.

In addition to the oxidized starch, one or more additional starch species may be applied. Such additional starch is different from oxidized starch and does not comprise oxidized starch. Such additional starch may for example be native, degraded or chemically modified. Native starch generally contains amylose and/or amylopectin as principal constituent. Native starch is generally not degraded and not chemically modified and not oxidized. Degraded starch generally has a lower average molecular weight than native starch. Starch degradation may take place, for example, enzymatically or by exposure to an acid or a base, more particularly by hydrolysis. This also leads generally to increased levels of oligosaccharides or dextrins. Through chemical modifications, chemical groups are attached via covalent addition to the starch, generally. For chemical modification, native or degraded starches may be used, for example. Chemical modifications are therefore generally different from degradation. Examples of chemical modifications are esterifications or etherifications, such as carboxymethyllation, or nonionic, anionic or cationic modifications. Examples of chemically modified starches are carboxymethyl-, methyl-, hydroxyethyl- or hydroxypropyl-starch, starch ethers or starch phosphate esters.

The starch hybrid copolymers are preferably not based on such additional starch.

The starch hybrid copolymers may optionally be protective colloid-stabilized or preferably emulsifier-stabilized. In one preferred embodiment the starch hybrid copolymers are not protective colloid-stabilized.

Examples of protective colloids are polyvinyl alcohols, polyvinyl acetals, polyvinylpyrrolidones, copolymers of (meth)acrylates with carboxyl-functional comonomer units, poly(meth)acrylamide, polyvinylsulfonic acids and their copolymers, melamine-formaldehyde sulfonates, naphthalene-formaldehyde sulfonates, styrene-maleic acid copolymers and vinyl ether-maleic acid copolymers. Preferred protective colloids are partially hydrolyzed polyvinyl alcohols preferably with a degree of hydrolysis of 80 to 95 mol %, more particularly 85 to 92 mol %. The polyvinyl alcohols have preferably a Höppler viscosity, in 4% strength aqueous solution, of 1 to 30 mPas, more particularly 3 to 15 mPas (Höppler method at 20° C., DIN 53015). The stated protective colloids are accessible by methods known to the skilled person.

The protective colloid fraction is preferably 0 to 30 wt %, more preferably 0.1 to 25 wt % and even more preferably 0.5 to 20 wt %, based on the total weight of the starch hybrid copolymers.

Most preferably, the starch hybrid copolymers are not protective colloid-stabilized.

The starch hybrid copolymers are preferably not stabilized with starch. The starch included in the starch hybrid copolymers generally does not act as a protective colloid. In starch-stabilized polymers, the starch and the polymers are generally present merely in the form of conglomerates and/or blends. In starch-stabilized polymers the starch is substantially not attached to the polymers. The starch hybrid copolymers are therefore generally not starch-stabilized polymers.

Anionic, cationic or nonionic emulsifiers may be included. Anionic emulsifiers are preferred, nonionic emulsifiers particularly preferred.

Examples of anionic emulsifiers are alkyl sulfates, alkyl sulfonates or alkyl carboxylates having a chain length of 8 to 18 carbon atoms, alkyl or alkylaryl ether sulfates, sulfonates or carboxylates having 8 to 18 carbon atoms in the hydrophobic radical and up to 40 ethylene or propylene oxide units, alkyl- or alkylarylsulfonates having 8 to 18 carbon atoms, full esters and monoesters of sulfosuccinic acid with monohydric alcohols or alkylphenols, or phosphates, ether phosphates, phosphonates and ether phosphonates, and also combinations thereof.

Examples of nonionic emulsifiers are alkyl polyglycol ethers or alkylaryl polyglycol ethers having 8 to 40 ethylene oxide units or ethylene oxide/propylene oxide block copolymers having 2 to 40 EO and/or PO units or generally EO-PO copolymers, and also alkylpolyglycosides having 1 to 20 carbon atoms and also ether alkylpolyglycosides having 2 to 40 EO and/or PO units, or combinations thereof.

The emulsifier fraction is preferably 0 to 10 wt %, more preferably 0.1 to 5 wt % and most preferably 0.5 to 3 wt %, based on the total weight of the starch hybrid copolymers.

The starch hybrid copolymers in the form of aqueous dispersions have a solids content of preferably 10 to 80%, more preferably 30 to 70% and even more preferably 40 to 60%.

The Brookfield viscosity of the aqueous dispersions of the starch hybrid copolymers is preferably 50 to 50,000 mPas, more preferably 100 to 25,000 mPas and even more preferably 600 to 10,000 mPas (determined with a Brookfield viscometer at 23° C. and 20 rpm with a solids content of the dispersions of 50%).

Aqueous dispersions of the starch hybrid copolymers preferably have lower viscosities than mere blends of corresponding amounts of starch and corresponding copolymers.

The starch hybrid copolymers have weight-average particle diameters Dw of between preferably 100 and 10,000 nm, more preferably 200 and 8,000 nm and most preferably 300 to 6,000 nm. Dw is determined as described for the oxidized starch above.

In the starch hybrid copolymers, the oxidized starch is attached preferably via covalent bonds to the polymer of the ethylenically unsaturated monomers. The attachment may be made, for example, by grafting as part of the radically initiated polymerization, or by condensation reactions. A measure of the grafting density of the starch hybrid copolymers is the grafting rate. The grafting rate of the starch hybrid copolymers is preferably 40 to 85%, more preferably 40 to 80% and most preferably 40 to 75%. The grafting rate is determined by the following method. A dried film of the starch hybrid copolymers is continuously extracted in a Soxhlet extraction apparatus with toluene. The insoluble portion of said film which remains in the extraction thimble is a grafted fraction of the starch hybrid copolymers. Said insoluble portion is dried to give fraction 1. The portion swollen in the solvent is dried as well to give fraction 2. The ratio of the weight of the fraction 2 to the weight of the fraction 1 gives the grafting rate.

The starch hybrid copolymers preferably do not have a core-shell structure. The monomers are preferably copolymerized statistically. Oxidized starch is incorporated preferably statistically into the starch hybrid copolymers.

A further subject of the invention are processes for producing starch hybrid copolymers in the form of aqueous dispersions or water-redispersible powders by means of radically initiated polymerization, more particularly emulsion polymerization, in aqueous medium of ethylenically unsaturated monomers in the presence of starch and optional subsequent drying, characterized in that
the starch comprises oxidized starch and
the ethylenically unsaturated monomers comprise one or more vinyl esters and ethylene,
wherein the total amount of vinyl ester and ethylene is ≥81 wt.-%, based on the total weight of the ethylenically unsaturated monomers,
whereby no ethylenically unsaturated monomer bearing allyl-, epoxy-, silane- or N-methylol-groups is copolymerized.

The temperature for the polymerization is preferably 40° C. to 120° C., more preferably 50° C. to 95° C. In the case of copolymerization of gaseous comonomers such as ethylene, 1,3-butadiene or vinyl chloride, it is also possible to operate under superatmospheric pressure, generally between 5 bar and 100 bar.

The pH before and/or during polymerization is preferably 3 to 10, more preferably 3 to <5. The pH might be controlled in common way, for instance by addition of common acids, bases or preferably buffers. Examples of pH adjusting agents are NH₄OH, NaOH, sodium bicarbonate, sodium carbonate or mixtures thereof. Such measure is also helpful to solve the present object even better, particularly to obtain stable aqueous dispersions or to avoid gelation.

Suitable radical initiators are commonplace oil-soluble or water-soluble initiators. Examples of oil-soluble initiators are oil-soluble peroxides, such as tert-butyl peroxy-2-ethylhexanoate, tert-butyl peroxypivalate, tert-butyl peroxyneodecanoate, dibenzoyl peroxide, tert-amyl peroxypivalate, di(2-ethylhexyl) peroxydicarbonate, 1,1-bis(tert-butylperoxy)-3,3,5-trimethylcyclohexane, di(4-tert-butylcyclohexyl) peroxydicarbonate, dilauroyl peroxide, cumyl hydroperoxide, or oil-soluble azo initiators, such as azobisisobutyronitrile or dimethyl 2,2′-azobis (2-methylpropionate). Examples of water-soluble initiators are peroxodisulfates, such as potassium peroxodisulfate, hydrogen peroxide, water-soluble hydroperoxides such as tert-butyl hydroperoxide, manganese(III) salts or cerium(IV) salts. The initiators are used generally in an amount of 0.005 to 3.0 wt %, preferably 0.01 to 1.5 wt %, based in each case on the total weight of the ethylenically unsaturated monomers. The use of redox initiators is preferred. Redox initiators used are combinations of the stated initiators in combination with reducing agents. Examples of suitable reducing agents are sodium sulfite, iron(II) salts, sodium hydroxymethanesulfinate and, particularly, ascorbic acid and isoascorbic acid or their salts, preferably alkali salts. Preferred redox initiators are cerium(IV) salts, such as ammonium cerium(IV) nitrate, manganese(III) salts or peroxodisulfates, and, particularly, hydrogen peroxide or water-soluble hydroperoxides such as tert-butyl hydroperoxide. Where reducing agents are used, the amount of reducing agent is preferably 0.01 to 0.5 wt %, based on the total weight of the ethylenically unsaturated monomers.

The Redox initiators, particularly with the above preferred reducing agents and/or redox initiators, are particularly beneficial for solving the present object and for achieving beneficial effects of the present invention, such as biodegradability.

The reaction mixture may be stabilized, for example, by protective colloids and/or preferably emulsifiers, preferably as described above.

The polymerization may be carried out with all or individual constituents of the reaction mixture included in the initial charge, or with some included in the initial charge and all or individual constituents of the reaction mixture metered in subsequently, or by the metering method without an initial charge. The procedure is preferably such that at least a part, preferably the entire amount, of starch, particularly the oxidized starch, is included in the initial charge, in particular in water. The ethylenically unsaturated monomers and the initiators are included entirely or preferably partly in the initial charge, and the remaining amount, where appropriate, of ethylenically unsaturated monomers and initiators is metered in. Where a batch process is carried out, the monomers and the starch and also a part of the initiator are included in the initial charge in water, and the initiator remainder is metered in or added in pulses.

Emulsifiers and/or protective colloids, if applied, are preferably applied in the initial charge.

Most preferably, the starch, particularly the oxidized starch, and optionally emulsifiers and/or protective colloids and optionally one or more additives are first dispersed or dissolved in water and afterward combined with the ethylenically unsaturated monomers and the initiators as described above. The starch, particularly the oxidized starch, and optionally emulsifiers and/or protective colloids and optionally one or more additives are preferably mixed in water at temperatures between 55 to 95° C. The thus obtained solution might be applied directly in the present process or cooled to appropriate temperature, such as room temperature, beforehand. By this, the starch, particularly the oxidized starch, is preferably gelatinized or emulsified. Such measures are also helpful to solve the present object even better, particularly to obtain stable aqueous dispersions or to avoid gelation.

After finishing polymerization, the pH is preferably adjusted to 3 to 10, more preferably to 4 to 9, even more preferably to >5 to 8, most preferably to 7 to 8. Measures for adjusting the pH are described above exemplarily. Such measure is also helpful to solve the present object even better, particularly to obtain stable aqueous dispersions or to avoid gelation.

After finishing polymerization, one or more additives might be added to the obtained polymer dispersion, such as defoamers. Examples of defoamers are oil based defoamer, water based defoamer, particularly silicone based defoamer, EO/PO based defoamer, alky polyacrylate or mixtures thereof. An amount of up to 3 wt %, particularly 0.1 to 1.5 wt % of additives, particularly defoamer, based on the starch hybrid copolymer, is preferred.

After the end of the polymerization, residual monomers may be removed by post-polymerization using known methods. Volatile residual monomers and other volatile constituents may also be removed by distillation or stripping methods, preferably under reduced pressure.

Aqueous dispersions of the starch hybrid copolymers may be converted by drying into starch hybrid copolymers in the form of water-redispersible powders. For this purpose the aqueous dispersions are generally admixed with drying assistants, preferably 0.5 to 30 wt %, more particularly 5 to 20 wt %, based on the solids content of the aqueous dispersion. The total amount of drying assistant and the optional protective colloid before the drying operation is preferably 1 to 30 wt %, based on the solids content of the aqueous dispersion. Examples of drying assistants are the above described protective colloids.

The aqueous dispersions may be dried for example by fluidized bed drying, freeze drying or, preferably, spray drying. The spray drying may be carried out in customary spray drying units, where atomization may take place using single, double or multiple fluid nozzles or with a rotating disk. The exit temperature chosen is generally in the range from 45° C. to 120° C., preferably 60° C. to 90° C., according to unit, Tg of the starch hybrid copolymer and desired drying level. The viscosity of the feed for atomization is adjusted via the solids content to a value of <500 mPas (Brookfield viscosity at 20 revolutions and 23° C.), preferably <250 mPas. The solids content of the dispersion for atomization is preferably 30 to 75 wt % and more preferably 50 to 60 wt %.

In many cases an amount of up to 1.5 wt % of antifoam agent, based on the starch hybrid copolymer, has proven useful. Antifoam agent is added preferably during the atomization.

In order to extend the shelf life by improving the blocking stability, particularly in the case of starch hybrid copolymer powders with low glass transition temperature, the resulting powder may be equipped, for example, with one or more antiblocking agents (anticaking agents). The antiblocking agents are preferably added not to the aqueous starch hybrid copolymer dispersions, i.e. preferably not before drying, but instead preferably during or after the drying, more particularly during the drying, into the spray drying unit. Preferred powders contain antiblocking agent, more particularly 1 to 30 wt %, based on the total weight of polymeric constituents. Examples of antiblocking agents are Ca and/or Mg carbonate, talc, gypsum, silica, kaolins such as metakaolin, silicates, preferably with particle sizes in the range from 10 nm to 10 μm.

The starch hybrid copolymers are suitable generally as binders for coating compositions or adhesive bonding compositions, in particular for paints, fibres, textiles, leather, paper or carpets. A particularly preferred use of the starch hybrid copolymers is as binders for the binding of fibre materials, more particularly for the production of fabrics, such as nonwovens, woven and knitted goods, leather and furs, or carpets, or as binders for construction coatings, more particularly aqueous emulsion paints or powder paints.

Preferred is the use of the starch hybrid copolymers in adhesive or coating compositions for preparing flexible packaging, food containers, coffee capsules, straw, mulching films, pesticide coatings or fishing nets, or in compositions for 3D printing.

The starch hybrid copolymers are also suitable, furthermore, for use in chemical products in the construction industry. They may be used alone or in combination with conventional polymer dispersions or dispersion powders, optionally in conjunction with hydraulically setting binders such as cements (Portland, aluminate, trass, blast furnace, magnesia or phosphate cement), gypsum and waterglass for the production of levelling compositions, construction adhesives, renders, filling compounds, jointing mortars, grouts, external wall integrated coating systems or paints, such as powder paints. Among construction adhesives, tile adhesives or adhesives for exterior wall insulation systems are preferred fields of use. Preferred fields of application are also levelling compositions; preferred levelling compositions are self-levelling floor filling compounds and screeds.

The present starch hybrid copolymers advantageously enable the usage of the renewable raw material starch in polymer applications. Hereby, the starch hybrid copolymers show excellent biodegradability, even under home composting conditions. The starch hybrid copolymers of the invention in the form of aqueous dispersions, water-redispersible powders or corresponding aqueous redispersions advantageously are stable in storage, do not show a tendency towards separation or gelation, and enable access to homogeneous compositions, preferably even in case of aqueous dispersions having high solid contents of starch hybrid copolymers. The present starch hybrid copolymers are also preferably compatible with other formulation ingredients, such as petrochemical polymers or biopolymers. Surprisingly, the aqueous dispersions of the present starch hybrid copolymers are even more stable and provide better filming and mechanical properties than respective dispersions of copolymers stabilized by starch as protective colloid or containing starch added after polymerization.

Additionally, the aqueous dispersions of the starch hybrid copolymers are available with low viscosities which facilitates their processing in application recipes and enables the handling of dispersions with higher solid contents.

Films from the present starch hybrid copolymers are advantageously homogeneous and exhibit even beneficial mechanical properties, particularly favourable elongation or flexibility, impact strength.

The examples below serve for further elucidation of the invention.

### EXAMPLE 1

Starch Hybrid Copolymer with 20% Oxidized Starch:

With stirring, a laboratory autoclave (5 L) was charged with the following:
1545 g of deionized water,
4.36 g of citric acid,
0.764 g of sodium citrate,
16.4 g of sodium vinylsulfonate (25%) and
493 g of oxidized starch “SUN-SIZE” (tradename of the company Samyang; Mw~700,000 g/mol).

The pH was adjusted to 4.0 and 1.20 g of iron(II) ammonium sulfate were added. The autoclave was then evacuated and charged with nitrogen. 1397 g of vinyl acetate were added, the reactor was heated to 40° C., and 300 g of ethylene were injected. Then aqueous tert-butyl hydroperoxide solution (TBHP) (3%) was started at a rate of 45.3 g/h and aqueous sodium isoascorbate solution (5.7%) at a rate of 45.0 g/h. After the start of reaction, apparent from an increase in the internal temperature, the initiator rates were reduced (TBHP 16.6 g/h, sodium isoascorbate 16.4 g/h). From the start of reaction, the internal temperature was raised from 55° C. to 60° C. at a rate of 0.25° C./min. 60 min after the start of reaction, the metering of 246 g of vinyl acetate was commenced, at a rate of 123 g/h.

After the end of the monomer feeds, the initiator feeds continued for 60 min more. The batch was subsequently cooled to 30° C. and let down. 0.854 g of Silfoam SE2 (silicone-based antifoam emulsion) was added, followed by post-polymerization using 11.5 g of TBHP (10%) and 22.6 g of sodium isoascorbate (6.25%). The batch was adjusted to a pH of 6.0 with ammonia (12.5%) and preserved using hydrogen peroxide (10%).

The properties of the aqueous dispersion are listed in the below Table 1.

### Comparative Example 2

Blend of Vinyl Acetate-Ethylene Copolymer Dispersion with 20% Oxidized Starch:

A vinyl acetate-ethylene copolymer dispersion (85 wt. % vinyl acetate, 15 wt. % ethylene) was admixed with 20% oxidized starch “SUN-SIZE” (tradename of the company Samyang; Mw~700,000 g/mol).

The properties of the aqueous dispersion are listed in the below Table 1.

### Comparative Example 3

Starch Hybrid Copolymer with 20% Native Starch:

Comparative example 3 was conducted identically to Example 1, with the only difference, that the oxidized starch SUN-SIZE was replaced by the native starch, Corn Starch of the company Samyang.

The properties of the aqueous dispersion are listed in the below Table 1.

TABLE 1
Characterization of the dispersions of the
inventive and (Comparative) Examples 1~3:

| | | | Viscosity | | | |
|---|---|---|---|---|---|---|
| | SC | | BF20 | D_{w} | Dₙ | T_{g} |
| | [%] | pH | [mPas] | [μm] | [μm] | [° C.] |
| Ex. 1 | 53.0 | 7 | 3,000 | 3.618 | 0.214 | 12.2 |
| CEx. 2 | 52.0 | 6.8 | 80,000 | 2.120 | 0.667 | 12.5 |
| CEx. 3 | 51.0 | 7 | 500,000 | 5.218 | 0.714 | 13.0 |

### Determination of the Biodegradability:

The starch hybrid copolymers from the (Comparative) Examples were each applied to cellulose powder and tested for anaerobic biodegradability at 58±2° C. for 45 days in accordance with ISO 14855-1 and EL724 methods. The biodegradability is calculated relative to cellulose ((biodegradation of sample/biodegradation of cellulose)×100).

The test results are given in the following Table 2.

TABLE 2
test results for biodegradability:

| | starch contents | relative biodegradability |
|---|---|---|
| | (solids/solids) | compared to cellulose |
| | [%] | [%] |
| Ex. 1* | 20 | 70.1 |
| CEx. 2 | 20 | 64.0 |
| CEx. 3 | 20 | 69.0 |

In comparison to the blend of Comparative Example 2, the starch hybrid copolymers of Example 1 exhibit a significantly higher biodegradability and obtain a relative degradability rate of about 70.1% for 45 days, as evident from table 2. The present starch hybrid copolymers of Example 1 furnish also better biodegradability than the starch hybrid copolymer with native starch as shown with Comparative Example 3.

The starch hybrid copolymer dispersion of Example 1 shows also advantageous storage stability, forms homogeneous films, such as elongation, and the obtained films have beneficial mechanical properties.

Additionally, the aqueous dispersions of the starch hybrid copolymers of Example 1 show low viscosities compared to the dispersions of the Comparative Examples which facilitates their processing in application recipes and enables the handling of dispersions with higher solid contents.

1-15. (canceled)

1. Starch hybrid copolymers in the form of aqueous dispersions or water-redispersible powders obtainable by radically initiated polymerization in aqueous medium of ethylenically unsaturated monomers in the presence of starch and optionally subsequent drying,
characterized in that
the starch comprises oxidized starch and
the ethylenically unsaturated monomers comprise one or more vinyl esters and ethylene,
wherein the total amount of vinyl ester and ethylene is ≥81 wt. %, based on a total weight of the ethylenically unsaturated monomers,
whereby no ethylenically unsaturated monomer bearing allyl-, epoxy-, silane- or N-methylol-groups is copolymerized.

2. Starch hybrid copolymers in the form of aqueous dispersions or water-redispersible powders as claimed in claim 1, characterized in that the starch hybrid copolymers are based on 40 to 80 wt % of vinyl esters, based on a dry weight of the starch hybrid copolymers.

3. Starch hybrid copolymers in the form of aqueous dispersions or water-redispersible powders as claimed in claim 1, characterized in that the starch hybrid copolymers are based on 1 to 45 wt % of ethylene, based on a dry weight of the starch hybrid copolymers.

4. Starch hybrid copolymers in the form of aqueous dispersions or water-redispersible powders as claimed in claim 1, characterized in that the total amount of vinyl ester and ethylene is ≥91 wt. %, based on the total weight of the ethylenically unsaturated monomers.

5. Starch hybrid copolymers in the form of aqueous dispersions or water-redispersible powders as claimed in claim 1, characterized in that the total amount of vinyl ester and ethylene is 41 to 95 wt %, based on a dry weight of the starch hybrid copolymers.

6. Starch hybrid copolymers in the form of aqueous dispersions or water-redispersible powders as claimed in claim 1, characterized in that the ethylenically unsaturated monomers consist of one or more vinyl esters and ethylene.

7. Starch hybrid copolymers in the form of aqueous dispersions or water-redispersible powders as claimed in claim 1, characterized in that the oxidized starch has a carboxyl content expressed as sodium carboxylate of 0.1 to 6.0 wt. %, based on a total weight of the oxidized starch.

8. Starch hybrid copolymers in the form of aqueous dispersions or water-redispersible powders as claimed in claim 1, characterized in that aqueous solutions of the oxidized starch have Brookfield viscosities of 2 to 1,500 mPas (determined with a Brookfield viscometer at 60° C. and 20 rpm with a solids content of the solutions of 10%).

9. Starch hybrid copolymers in the form of aqueous dispersions or water-redispersible powders as claimed in claim 1, characterized in that the starch hybrid copolymers are based on 5 to 59 wt % of oxidized starch, based on a dry weight of the starch hybrid copolymers.

10. Starch hybrid copolymers in the form of aqueous dispersions or water-redispersible powders as claimed in claim 1, characterized in that the fraction of the oxidized starch is ≥50 wt %, based on a total weight of the starch included overall.

11. Starch hybrid copolymers in the form of aqueous dispersions or water-redispersible powders as claimed in claim 1, characterized in that the Brookfield viscosity of the aqueous dispersions of the starch hybrid copolymers is 50 to 50,000 mPas (determined with a Brookfield viscometer at 23° C. and 20 rpm with a solids content of the dispersions of 50%).

12. Processes for producing starch hybrid copolymers in the form of aqueous dispersions or water-redispersible powders by means of radically initiated polymerization in aqueous medium of ethylenically unsaturated monomers in the presence of starch and optional subsequent drying, characterized in that the starch comprises oxidized starch and the ethylenically unsaturated monomers comprise one or more vinyl esters and ethylene, wherein the total amount of vinyl ester and ethylene is ≥81 wt. %, based on the total weight of the ethylenically unsaturated monomers,
whereby no ethylenically unsaturated monomer bearing allyl-, epoxy-, silane- or N-methylol-groups is copolymerized.

13. Processes for producing starch hybrid copolymers in the form of aqueous dispersions or water-redispersible powders as claimed in claim 12, characterized in that the pH before and/or during polymerization is 3 to ≤5 and,
after finishing polymerization, the pH is adjusted to >5 to 10.

14. The use of the starch hybrid copolymers in the form of aqueous dispersions or water-redispersible powders as claimed in claim 1 in adhesives or in coating compositions or in chemical products in the construction industry.

15. The use of the starch hybrid copolymers in the form of aqueous dispersions or water-redispersible powders as claimed in claim 1 in adhesive or coating compositions for preparing flexible packaging, food containers, coffee capsules, straw, mulching films, pesticide coatings or fishing nets, or in compositions for 3D printing.
